(19) United States
(12) Patent Application Publication
(10) Pub. No.: US 2023/0004911 A1
(43) Pub. Date: Jan. 5, 2023

(54) EARLY-WARNING DATA-INFORMED BUSINESS SPEND AND ACTUATION

(71) Applicant: EMC IP Holding Company LLC, Hopkinton, MA (US)

(72) Inventors: Nicole Reineke, Northborough, MA (US); Stephen J. Todd, North Andover, MA (US)

(21) Appl. No.: 17/305,104

(22) Filed: Jun. 30, 2021

(51) Int. Cl. G06Q 10/06; G06Q 40/00

(52) U.S. Cl. CPC G06Q 10/06375; G06Q 40/12; G06Q 10/067

(57) ABSTRACT

Data management is disclosed that detects changes in production or potential changes in production to trigger business decisions that inform business spend. Sensor input meant to monitor manufacturing and event correlation data can serve as input to trigger business decisions. The decisions can account for cost structures to ensure automated investments in the interest of the business or other organization. The data management links an early understanding of production data and business decisions to increase the link between manufacturing investment and business spend and to decrease waste including economic waste.

### FIELD OF THE INVENTION

Embodiments of the present invention generally relate to data management and data informed decision making. More particularly, at least some embodiments of the invention relate to systems, hardware, software, computer-readable media, and methods for data management operations including data driven decision making operations.

### BACKGROUND

Many different businesses and technologies rely on data for many different reasons. For example, manufacturing environments use data to control aspects of the manufacturing process. For example, crops may be grown in a fully controlled environment warehouse. Sensors may be used to supply extensive data on the crops. The sensors may generate data describing biomass, moisture levels, light exposure, and the like. Data from these sensors can be used to control the use of water, light, and electricity and thereby optimize crop output.

Even though the environment can be controlled, human, technological, and biological idiosyncrasies may lead to variance in crop production. Further, even though sensor data can be used to monitor and manage crop production, the data that drives crop production, or manufacturing processes, are disconnected from business decisions such as marketing decisions and investment decisions.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a rules platform that is integrated with manufacturing processes to implement data informed business decisions;

FIG. 2A discloses aspects of a method for performing or informing business decisions;

FIG. 2B illustrates additional aspects of performing or informing business decisions using a rules engine;

FIG. 3 discloses aspects of an event correlation engine;

FIG. 4 discloses aspects of an event correlation engine; and

FIG. 5 discloses aspects of a computing device or a computing system.

### DETAILED DESCRIPTION OF SOME EXAMPLE EMBODIMENTS

Embodiments of the present invention generally relate to data informed data management. More particularly, at least some embodiments of the invention relate to systems, hardware, software, computer-readable media, and methods for data driven data management operations including business spend operations, manufacturing actuation operations, early-warning data informed operations, or the like.

As used herein, manufacturing is broad and relates to goods, services, biological, and/or other areas of production or other environments. In general, example embodiments of the invention receive input related to manufacturing, changes in production (production variability), local events and/or global events. Manufacturing is intended to encompass, by way of example only and not limitation, agriculture in controlled environments, bioengineering environments, goods, energy production and energy use, smart cities, other sensor enabled environments, and the like. Embodiments of the invention are configured such that this input informs business operations including marketing and investment operations in addition to controlling manufacturing or environment processes.

For example, data from sensors in a manufacturing environment that is used for controlling manufacturing processes also serves as input to trigger or inform business decisions. The decisions can account for cost structures to ensure that automated investments are in the best interest of the organization. For example, a business may regularly purchase advertisements or marketing for a specific crop. If data from the sensors indicate that the crop will be above average, embodiments of the invention may allow or cause automated marketing investments to change. An increased supply may allow a manufacture to increase sales and revenue and to better control marketing spend. Conventionally, early detection of a bumper crop is disconnected from marketing spend. Embodiments of the invention thus link the data used to inform or control manufacturing processes to inform business decisions.

Embodiments of the invention link an understanding of manufacturing or production data (e.g., sensor data) to business spend to decrease waste, optimize revenue, and the like. The data management operations can use sensor data meant for monitoring manufacturing to act as an early warning to trigger business decisions.

For example, an entity may grow food in a fully controlled environment. Sensors provide extensive data on crop growth and may be used to monitor or measure electricity use, plant grown, light levels, moisture levels, water usage, temperature, humidity, cultivation schedules, and the like. Extensive work is performed in an effort to control all aspects of the environment and ensure predictable crop rates and production. Embodiments of the invention allow business decision making operations to be performed. By way of example only, the sensor data can be analyzed to determine whether crops are stagnating, under producing, or overproducing. The early detection of excess or lean production can be used to trigger marketing or sales decisions. This allows a business to direct resources in a manner that accounts for the expected crops before the crops are ready for harvest. This allows a business to prepare for or adapt resource allocation, distribution, market locations, and the like early in the manufacturing process.

Embodiments of the invention may also use external input. For example, many businesses are impacted by events such natural disasters or unexpected weather, festivals, or other events that may have an impact (positive or negative) on a product being manufactured even when these events occur remotely with respect to the business. A late freeze or other event in one location, may have an impact on the market as a whole or in other locations or in locations relevant to the business. Embodiments of the invention use, as input, external information about natural disasters, projected weather patterns, festivals, other events that may influence production or consumption or the like to drive business decisions.

A disaster that impacts avocados produced by a competitor or in another geographic location may be used to direct resources to avocado growth. This event could influence revenue, pricing, marketing or the like. Using data relevant to the event as an early warning or indicator of future conditions allows businesses to take advantage of or reduce the impact of these external events. In addition to influencing business decisions such as marketing and spend decisions, the impact that these types of events may have on sales/production/availability can be used to perform operations in the manufacturing environment to increase or decrease yield, conserve or use resources, or the like. Embodiments of the invention allow an entity to prevent or reduce the investment in unsellable goods due to, for example, over production, low demand, or missed revenue opportunities. Similarly, external events may be used to increase production or further optimize production, change distribution plans, change marketing plans and spend, adjust budgets, or the like or combination thereof.

Conventional mechanisms for business decisions such as marketing spend reside in marketing solutions such as adwords, clickfunnels, and other enterprise tools. Embodiments of the invention, however, link the processes, tools, and data used to measure manufacturing processes to business decisions including marketing and sales.

Many manufacturing environments have actuation capabilities that can increase/decrease production. In crop manufacturing, for example, the yield can be increased using heat/moisture or stopped by cutting electricity. Increasing or decreasing production has an associated cost. Embodiments of the invention allow input to drive business decisions and/or allow manufacturing actuations to be performed. For example, an environmental event that impact the production of avocados may allow a business that has avocados to take business actions and/or manufacturing operations. The environmental event may drive a decision to increase marketing spend and/or manufacturing operations to optimize crop production.

Embodiments of the invention can incorporate information relating to external events that have an economic impact into immediate actuation. Embodiments of the invention provide a link between external events, anticipated events, and actuation.

Embodiments of the invention provide a data management platform that associates sensor data, manufacturing data, business cost and spend data, business process data, and secondary sources. This data can be tagged or labeled with tags. Rules can be operated with respect to the tags. A rules engine may store various definitions including tag values and business decisions related to the detected tags. The rules engine may also define triggers based on the tags or their values. Example decisions may include increasing/decreasing controlled demand, budget allocation, production spend, marketing spend, process decisions, or the like.

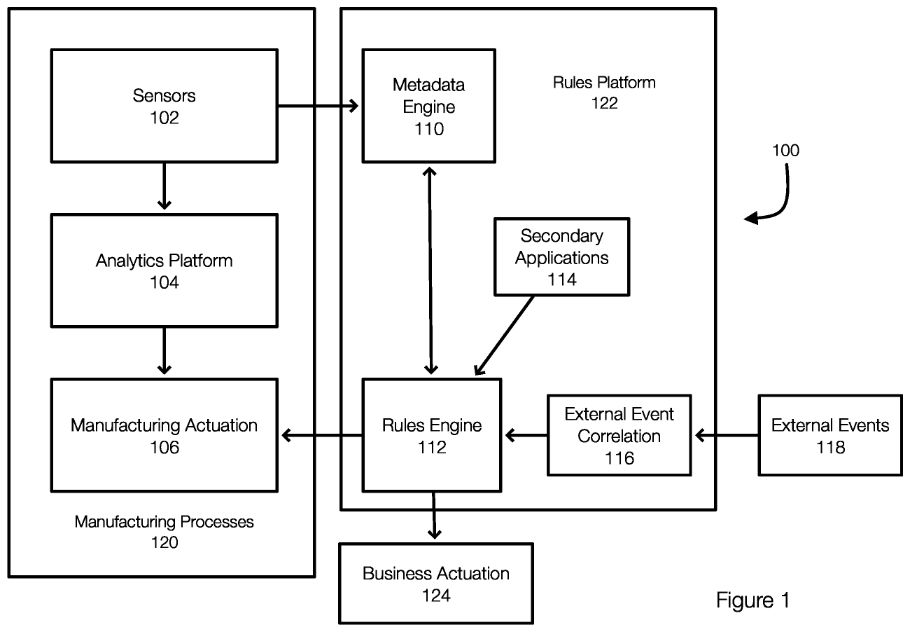

FIG. 1 discloses aspects of a data management system. The data management system 100 is configured to identify information that may be related to or that may impact production and trigger business decision points to divert or adjust spending and/or to trigger manufacturing actuations.

More specifically, the data management system 100 integrates the processes, tools, and data used in manufacturing processes into business decisions. The data management system allows business decisions to be based on factors that may impact production or create production variability.

The data management platform 100 integrates manufacturing processes 120 with a rules platform 122. The rules platform 122 allows the information used in or generated in the manufacturing processes 120, external events, secondary applications, and other sources of data to influence the manufacturing processes 120. The rules platform 122 enables business decisions to be implemented earlier, thereby optimizing an entity's operations and business decisions including production, marketing, and sales decisions.

In one example, the data management platform 100, which may be implemented in or connected to a manufacturing environment, may include or have access to sensors 102. The sensors 102 deployed in the manufacturing environment may depend on the purpose of the environment. An agriculture manufacturing environment, for example, may include sensors to detect light, heat, humidity, temperature, biomass, growth rates, cameras, and other sensors related to the crop production. Some of this information may be generated by processing sensor output. A environment manufacturing goods may include different collections of sensors that relate to the good being produced or the machines producing the goods.

The manufacturing processes 120 often begin by ingesting data from sensors 102 into an analytics platform 104. The analytics platform 104 uses to data to implement manufacturing actuation 106. For example, the data from the sensors may indicate that crop growth has slowed, or that soil is too dry, or that the temperature has dropped. This information is used to alter the manufacturing operations. For example, additional water may be used for irrigation, the temperature may be increased, light may be increased, or the like. Generally, the manufacturing actuation 106 is performed to optimize production.

The manufacturing processes 120, by themselves, are conventionally disconnected from sales, marketing, and other spend decisions. Stated differently, in conventional environments, there is a significant time delay before data related to manufacturing or that may impact manufacturing is accounted for in production reports, sales decisions, marking decisions, increased/decreased spend, and the like.

The rules platform 122 is configured to reduce this delay and allows business decisions and/or manufacturing actuation 106 to be implemented more quickly or earlier compared to conventional systems. This allows data that may impact production (of the manufacturer and/or other manufacturers) to be acted on earlier. This allows resources to be used more effectively, allows actions to be taken to increase/decrease production, account for market changes, and the like. This also facilitates business decision such as marketing spend or investment spend, budget allocation, and the like.

In this example, data from the sensors 102 is also ingested into or input into a metadata engine 110 of a rules platform 122. The metadata engine 110 is configured to create tags for the ingested data. Stated differently, metadata tag or label generation includes generating data content labels (referred to herein as tags). For example, information from a thermometer may be tagged with a various tags including a value tag for the measured temperature, a location tag for the location of the sensor (e.g., row, room building, city). The metadata engine 110 may collect data over time such that metadata tags can be generated for time series data and the like.

In another example, in an agriculture manufacturing environment (e.g., growing crops), growth rates from lettuce may be tagged as with a value tag, crop type or variety tag, location tag, and the like. The rule-based tagging can account for origin of the sensor data, location of the sensor data, type or species of crop, date planted time of day, and the like or combination thereof. The values of the data can also be tagged. By tagging data, rules can be executed on the tags. For example, a rule may look for temperature values from a particular location that are outside of a predefined range. From a manufacturing perspective, this may allow the manufacturing processes 120 to determine that the temperature needed for optimal growth needs to be adjusted. The tags generated and applied to the data from the sensors 102 can vary and can be determined by the manufacturer or set by default. Each sensor may be associated with tags that may be populated in the metadata engine 110.

The rules engine 112 may execute rules on the tags. Thus, the tags can be used to detect when the metadata or data from the sensors 102 meets a rule or a rule specification. This may be a detection of a specific value, a set of values, values within/without a range, variation in values from expected values, or the like. The rules engine 112 may also perform processing in the context of executing rules. For example, the rules engine 112 determine a percent variation from the detected value or from a determined or desired value. If the percent variation is a decrease in production and by way of example only, the rule may cause an automated notification to be generated to decrease marketing spend. Thus, the rules engine 114 can have an impact on business decisions. In addition, the rules engine 112 may also include rules that are configured to cause manufacturing actuations 106. Advantageously, business decisions and manufacturing actuations can be implemented jointly.

The rules engine 112 may also receive input from secondary applications such as manufacturing and marketing applications. The rules engine 112 may also detect variance in data from secondary applications 114. The rules engine 112 may also perform external event correlation 116. Using application programming interfaces (APIs) or other connectivity, the external event correlation may be able to receive input related to and analyze external events 118. For example, the external event correlation 116 may connect or periodically access a weather database, databases or websites with information that may be relevant to or related to the manufacturing being performed. For example, if avocados are being manufactured, the external events 118 may include weather or disaster-based resources (e.g., weather forecasts, event impact reporting), websites related to areas where demand is increasing/decreasing, information on events such as festivals that may impact the manufactured produce, or other data sources including a history of supply and demand, or the like.

These inputs can be used to perform manufacturing actuation 106 and/or business actuation 124. Business actuation 124 may include notifications regarding spend recommendations (increase/decrease marketing, increase/decrease asset investment, etc.). Manufacturing actuation 106 may include adjusting production to account for the impact or the potential impact represented by the data from the external events, the sensors 102, and/or the secondary applications 114. Embodiments are able to be implemented quickly in response to the input to the rules platform 122 or, more specifically, to the rules engine 112.

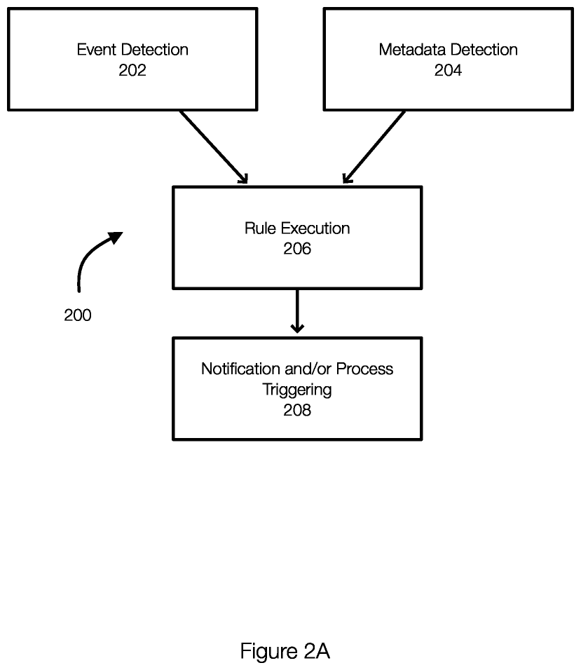

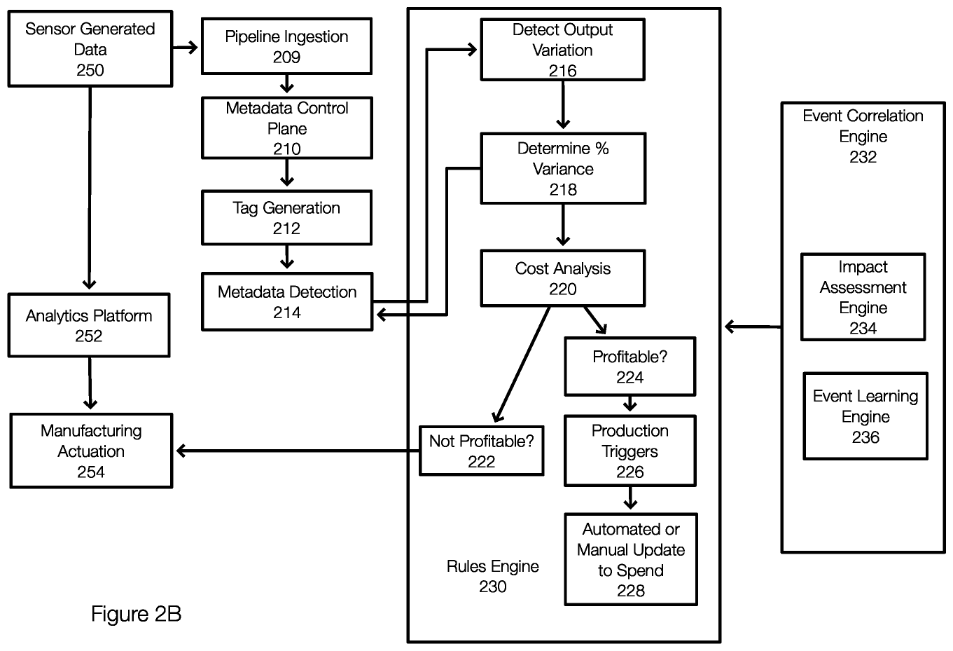

FIG. 2A discloses aspects of a method for performing data driven business actuation. In example, event detection 202 and metadata detection 204 are performed. Event detection 202 may include monitoring external events that may impact production. As previously stated, weather events, disasters, strikes, drought, festivals, demographics, and the like are examples of events or data that may influence business decisions. For example, a geographic area may be monitored for extreme frost, which would impact lettuce production. When this event is detected during a competitive growing season, an early notification to manufacturing to increase lettuce production to accommodate crop shortages may be issued. This may also benefit from higher market pricing, due to the shortage, and increase revenue.

If an event is an event that impacts distribution, the distribution impact may be assessed. For example, a blizzard (or an anticipated blizzard) may impact a geographical area and result in spoiled or unconsumed goods and lost revenue. The cost/value of rerouting perishable goods to another consumption location when the event is detected or anticipated can be evaluated and a decision can be made regarding whether to revise product distribution. This may allow better pricing to be acquired before competitors can detect a challenge or prevent goods from spoiling, thereby avoiding waste and lost revenue. The event detection 202 may use event learning engines models such that notifications or business actuations are improved training a model with past events.

In one example, the content labeling may be performed on the detected events and other inputs. Next, rules are executed 206 by a rules engine on the labeled data or on the tags. Notification and/or process triggering 208 is performed based on the rule execution. For example, in the case of extreme frost, the notification or process triggering may include a business actuation to increase marketing in other areas, to reroute crops to the affected areas, to change pricing, to invest in additional plantings, or the like. The notification or process may also trigger a manufacturing actuation such as increasing crop output. Events such as a bumper crop may result in a business actuation to reduce or stop production if economical, to reduce spending, to seek other markets, or the like.

FIG. 2B discloses aspects of data management and data management operations. FIG. 2B illustrates manufacturing processes such as generating 250 sensor data, providing an analytics platform 252 to receive the data generated by the sensors and generate an output than triggers manufacturing actuation 254. FIG. 2 further illustrates aspects of linking the sensor input (and other input) to business decisions.

The generated sensor data 202 is ingested by a pipeline 209. As the ingested data from the sensors in the pipeline 209 enters the control plane 210, tags can be generated 212 and assigned to the data being ingested. The rules engine may perform metadata detection 214 and detect an output variation 216. Other outputs may depend on the rules executed against the input. Thus, the output variation detected by the rules engine depends on the rule. Next, the percentage of variation is determined 218 in one example.

More generally, one or more rules may be executed on the tags. These rules may generate a percentage variance 218. The rules may also generate other outputs. and a cost analysis 220 may be performed based on the variance 218 or other outputs. The cost analysis 220 may be based on the rule. For example, the data from the sensors may indicate that that the production expected (based on weight or other factors) from a certain crop is 50% below normal. This may be based on expected growth, comparisons with previous crops, or the like. As a result a cost analysis 220 is performed to determine whether the cost of bringing the crop to harvest is profitable 224 or not profitable 222. If profitable 224, production triggers 226 may generate reports to sales or marketing such that these departments can make decisions based on the expected crop, which is below normal in this example. In addition, this may generate updates to manually or automatically update spending for advertisements and sales channels.

If not profitable 222, this may result in output to manufacturing actuation 206, which may cease operation with respect to the crop and incur no further expense. As a result, the early indicator can provide information to take actions to achieve savings or that may increase revenue.

In another example, the event correlation engine 232 may indicate, for the crop that is expected to under produce, that an event at another location has destroyed the same crop. As a result, a 50% crop becomes more valuable to the manufacturer and the business decision may be different when more information is considered. In this instance, it may be more beneficial to devote more resources to the crop and to increase marketing. The event correlation engine 232 allows the rules engine 230 to consider external events (e.g., weather patterns, festivals, competitor announcements, crop expectations, expected demand, market conditions) that may impact decision making. Embodiments of the invention can more quickly adapt to these conditions.

The event correlation engine 232 may include an impact assessment engine 234 and an event learning engine 236. The impact assessment engine 232 may be a model configured to correlate the impact of an event to accuracy. The impact learning engine 236 is configured to perform actual outage monitoring and to provide feedback to improve learning.

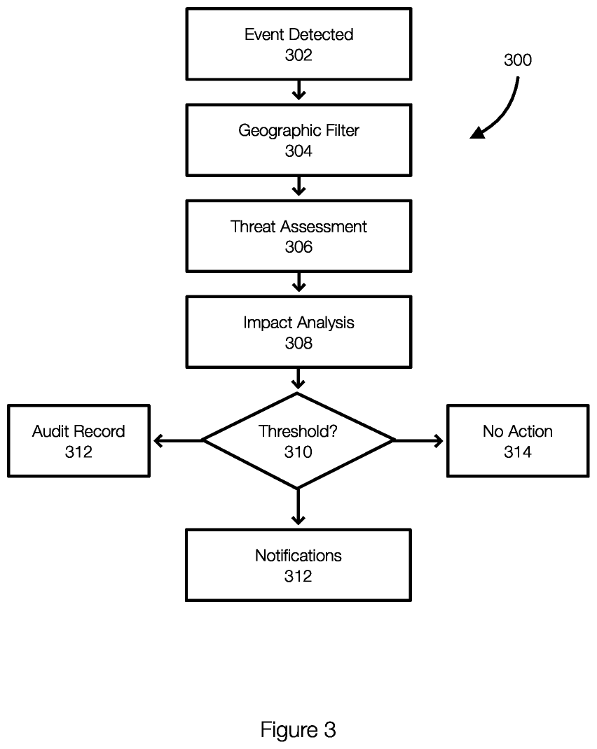

FIG. 3 discloses aspects of event correlation. The method 300 may initially begin by detecting 302 an event. For example, the event correlation engine may receive event data via an API. Once the event is detected, a geographic filter 304 is performed. The geographic filter may determine whether the event could impact any location relevant to the business. The method 300 continues if any relevant location is identified and a threat assessment 306 is performed. The threat assessment 306 may identify the nature of the event (e.g., destructive (e.g., freeze) or productive (e.g., festival). The radius or geographic impact of the event and a time frame may also be determined.

The event correlation engine may have a database that stores events. Events may be associated with metadata including type, severity, impact potential, and the like. Thus, an entry may be created for a new event and could be compared to previous similar events. Secondary sources may be used for correlation where available. Thus, a threat assessment 306 is performed.

For each area of impact, an impact analysis 308 may be performed. This may include determining a potential consumption impact assessment. For example, the assessment may determine whether rerouting is required, whether routing or distribution capability is available, the time to move and the cost to move the product. This allows a cost analysis to be performed in view of the event.

A potential production impact assessment may also be performed. The cost of production, the time to production, the cost to manufacture is evaluated, and the consumption distribution is evaluated. This allows a cost/opportunity analysis to be performed.

The method 300 then may perform a threshold monitoring 310. If the threshold, time, cost analysis does not meet requirements, an audit record is generated 312. If the event does not occur, no action 314 is taken. If the threshold, time, and cost analysis satisfy requirements, notifications 312 are triggered. For example, a change in production is estimated to increase sales by 9%. If the threshold is 10%, no actuation is triggered. If a planned festival is estimated to increase sales by 10%, this is over a 10% threshold and results in potential business actuation (e.g., an increase in social media spending to target event attendees) or potential manufacturing actuation (increasing production on item to be sold at the event).

The thresholds evaluated can vary. From a cost analysis perspective, the inputs may need to impact sales by 10% before an actuation is triggered. However, the threshold could also be set with respect to other factors such as geography. If an event, for example, impacts a certain percentage of land used to grow a particular product, then an actuation may be initiated. However, the threshold is typically set with respect to spend, cost, sales, revenue, profit, or the like or combination thereof. If the input (sensor input, event input, etc.) suggests that one of these factors is expected to change by more than a threshold value, actuations may be initiated.

Thus, embodiments of the invention allow events (and potential events) to serve as early warnings to trigger or initiate business decisions. Anticipating the cost (e.g., revenue, loss, opportunity) to be evaluated early (e.g., before an event occurs or when the event occurs) allows an entity to reduce or minimize losses, change spending for marketing, sales, and other business costs, change budget allocations, allocate resources, reconfigured distributions, and the like. An entity may also be able to initiate manufacturing actuations. This may include ceasing or reducing production, which can prevent further costs from being incurred. This may also include attempting to optimize existing production or increase production. These decisions are informed by data driven information from various sources including manufacturing data, event data, secondary application data, and the like or combination thereof.

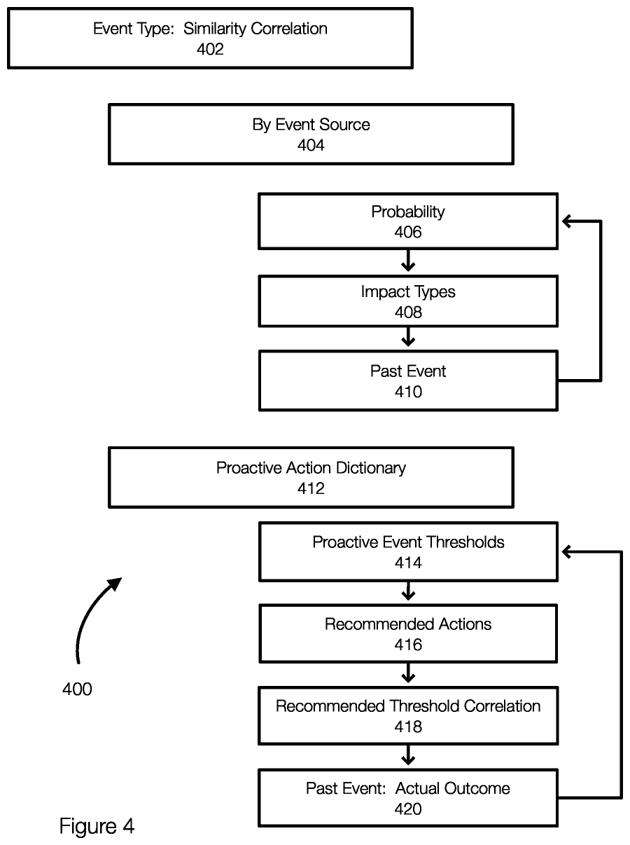

FIG. 4 discloses aspects of an event correlation engine or portion thereof. The system 400 may evaluate an event to determine a similarity correlation 402. The system 400 may perform the similarity correlation 402 by be performed based on event source 404. This may include evaluating a probability 406 of the severity. The event may be required to satisfy a threshold probability before action is taken. The impact type 408 is also determined. The impact type may identify a radius of impact and an estimation of the time to impact from the initial alert. The ability to make business decisions with more lead time may lead to better results. The event source 404 may also be evaluated in terms of a past event 410. For example, how did the probability change over time and what was the actual outcome of the past event 410. These aspects can be executed as a loop of continuous improvement such that the event correlation engine can continually improve.

In one example, the event correlation engine 400 may learn such that events can be identified more and more in advance. This can provide a competitive advantage as business spend can be adjusted earlier and the business can have more time to implement any execution actions such as preparing for production, preparing for distribution, securing distribution routes, identifying markets for distribution, and the like.

The similarity correlation 402 may also include a proactive active dictionary 412 that associates event type with source thresholds and probabilities. For example, proactive actions are identified based on event thresholds. If an event crosses a threshold such as a severity threshold, a geographic area threshold, a revenue threshold, a sales threshold, a loss threshold, or the like, actions can be predefined or recommended. Actions 416 can also be identified by threshold and by priority. Thus, depending on the threshold and/or the priority, actions can be recommended. For example, actuations with respect to crops that have a short growing season may have a higher priority than crops with a longer growing season. Planting schedules, combined with event timing or expected event timing, may be used to prioritize actuations. Actuations may impact the business as a whole or be targeted to specific products (e.g., specific crops).

The recommended threshold correlation 418 may be evaluated across thresholds. If an event is critical, an action may be initiated. These thresholds and actions can be evaluated based on past events. In this example, a loop of improvement may also be implemented such that accuracy improves over time.

In generally, the event correlation engine may have a database of dictionary that stores information about past events and their outcomes. When a new event is identified, information may be gathered and a model may be able to generate an inference based on the model, which was trained on past events and past outcomes. The inference or prediction may be a notification to perform a particular business action. The model can be configured to generate various inferences based on the event.

Generally, embodiments of the invention receive input from events and/or related to anticipated events, manufacturing sensors, and other secondary sources to inform business decisions.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations to achieve data informed business spend and actuation. More generally, the scope of the invention embraces any operating environment in which the disclosed concepts may be useful.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way. [

Embodiment 1. A method, comprising: generating tags for data received from sensor in a manufacturing environment, executing rules on the tags to identify variations in values of the data compared to expected values of the data, performing a cost analysis to compare a cost of completion with sales and/or marketing investment, triggering a first notification when the cost analysis indicates profitability to initiate a business actuation, and triggering a second notification to initiate a manufacturing actuation when the cost analysis does not indicate profitability.

Embodiment 2. The method of embodiment 1, further comprising determine a percentage of the variations.

Embodiment 3. The method of embodiment 1 and/or 2, further comprising receiving event information related to an anticipated event or an occurring event.

Embodiment 4. The method of embodiment 1, 2, and/or 3, further comprising analyzing the event including one or more of a geographic impact of the event, a nature of the event, a radius of the event, a time frame of the event and performing a threat assessment.

Embodiment 5. The method of embodiment 1, 2, 3, and/or 4, further comprising an impact analysis that analyzed an impact on consumption and an impact on production.

Embodiment 6. The method of embodiment 1, 2, 3, 4, and/or 5, wherein the impact on consumption includes an analysis on a total product impact, available distribution to a new area, time to distribute the product, and a cost to move the product, wherein the impact on production includes an analysis on a cost of production, a time to production, and a cost to create consumption pipeline.

Embodiment 7. The method of embodiment 1, 2, 3, 4, 5, and/or 6, further comprising monitoring a threshold and generating the first notification when a threshold for the event is exceeded.

Embodiment 8. The method of embodiment 1, 2, 3, 4, 5, 6, and/or 7, wherein the business actuation relates to increasing or decreasing marketing spend and/or sales spend.

Embodiment 9. The method of embodiment 1, 2, 3, 4, 5, 6, 7, and/or 8, wherein the manufacturing actuation relates to optimizing or reducing manufacture.

Embodiment 10. The method of embodiment 1, 2, 3, 4, 5, 6, 7, 8, and/or 9, further comprising performing machine learning to increase a time between detection of an anticipated event and occurrence of the event.

Embodiment 11. A method, comprising: generating tags for data received from sensors in a manufacturing environment configured to manufacture a product, executing rules on the tags to identify variations in values of the data compared to expected values of the data, performing a cost analysis to compare a cost of manufacturing the product with sales and/or marketing investment, and triggering a first notification to initiate a business actuation based on a result of the cost analysis

Embodiment 12. The method of embodiment 11, further comprising receiving event information related to an anticipated event or an occurring event.

Embodiment 13. The method of embodiment 11 and/or 12, further comprising: analyzing the event information to determine one or more of a geographic impact of the event, a nature of the event, a radius of the event, a time frame of the event and performing a threat assessment, and performing an impact analysis that analyzes an impact of the event on consumption and an impact of the event on production, wherein the impact on consumption includes an analysis on a total product impact, available distribution to a new area, time to distribute the product, and a cost to move the product, wherein the impact on production includes an analysis on a cost of production, a time to production, and a cost to create consumption pipeline.

Embodiment 14. The method of embodiment 11, 12, and/or 13, further comprising triggering a second notification to initiate a manufacturing actuation based on the result of the cost analysis, wherein the cost analysis accounts for a cost associated with the event.

Embodiment 15. The method of embodiment 11, 12, 13, and/or 14, further comprising monitoring a threshold and generating the first notification when a threshold for the event is exceeded.

Embodiment 16. The method of embodiment 11, 12, 13, 14, and/or 15, wherein the business actuation relates to increasing or decreasing marketing spend and/or sales spend, and wherein the manufacturing actuation relates to optimizing or reducing manufacture.

Embodiment 17. The method of embodiment 11, 12, 13, 14, 15, and/or 16, further comprising performing machine learning to increase a time between detection of an anticipated event and occurrence of the event.

Embodiment 18. A method for performing any of the operations, methods, or processes, or any portion of any of these, disclosed herein of one or more of the embodiments disclosed herein.

Embodiment 19. A non-transitory storage medium having stored therein instructions that are executable by one or more hardware processors to perform operations comprising the operations of any one or more of or portions of embodiments 1 through 18.

The embodiments disclosed herein may include the use of a special purpose or general-purpose computer including various computer hardware or software modules, components, engines, or the like as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

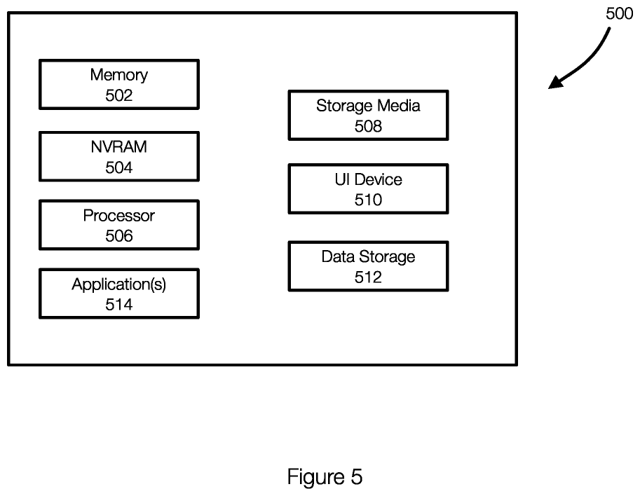

With reference briefly now to FIG. 5 any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5. Embodiments may also be implemented in containers and containerized environments.

In the example, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
generating tags for data received from sensors in a manufacturing environment configured to manufacture a product;
executing rules by a rules engine on the tags to identify variations in values of the data compared to expected values of the data;
performing a cost analysis to compare a cost of manufacturing the product with sales and/or marketing investment;
triggering a first notification to initiate a business actuation based on a result of the cost analysis, wherein the first notification is triggered before of when an even occurs and business actuation includes spend recommendations; and
performing the business actuation based on the result of the cost analysis.

2. The method of claim 1, further comprising receiving event information related to an anticipated event or an occurring event.

3. The method of claim 2, further comprising:
analyzing the event information to determine one or more of a geographic impact of the event, a nature of the event, a radius of the event, a time frame of the event and performing a threat assessment, and
performing an impact analysis that analyzes an impact of the event on consumption and an impact of the event on production, wherein the impact on consumption includes an analysis on a total product impact, available distribution to a new area, time to distribute the product, and a cost to move the product, wherein the impact on production includes an analysis on a cost of production, a time to production, and a cost to create consumption pipeline.

4. The method of claim 2, further comprising triggering a second notification to initiate a manufacturing actuation based on the result of the cost analysis, wherein the cost analysis accounts for a cost associated with the event.

5. The method of claim 4, further comprising monitoring a threshold and generating the first notification when a threshold for the event is exceeded.

6. The method of claim 2, wherein the business actuation relates to increasing or decreasing marketing spend and/or sales spend, and wherein manufacturing actuation relates to optimizing or reducing manufacture.

7. The method of claim 1, further comprising performing machine learning to increase a time between detection of an anticipated event and occurrence of the event.

8. A non-transitory storage medium having stored therein instructions that are executable by one or more hardware processors to perform operations comprising:
generating tags for data received from sensors in a manufacturing environment configured to manufacture a product;
executing rules by a rules engine on the tags to identify variations in values of the data compared to expected values of the data;
performing a cost analysis to compare a cost of manufacturing the product with sales and/or marketing investment;
triggering a first notification to initiate a business actuation based on a result of the cost analysis, wherein the first notification is triggered before of when an even occurs and business actuation includes spend recommendations; and
performing the business actuation based on the results of the cost analysis.

9. The non-transitory storage medium of claim 8, further comprising receiving event information related to an anticipated event or an occurring event.

10. The non-transitory storage medium of claim 9, further comprising:
analyzing the event information to determine one or more of a geographic impact of the event, a nature of the event, a radius of the event, a time frame of the event and performing a threat assessment, and
performing an impact analysis that analyzes an impact of the event on consumption and an impact of the event on production, wherein the impact on consumption includes an analysis on a total product impact, available distribution to a new area, time to distribute the product, and a cost to move the product, wherein the impact on production includes an analysis on a cost of production, a time to production, and a cost to create consumption pipeline.

11. The non-transitory storage medium of claim 9, further comprising triggering a second notification to initiate a manufacturing actuation based on the result of the cost analysis, wherein the cost analysis accounts for a cost associated with the event.

12. The non-transitory storage medium of claim 11, further comprising monitoring a threshold and generating the first notification when a threshold for the event is exceeded.

13. The non-transitory storage medium of claim 9, wherein the business actuation relates to increasing or decreasing marketing spend and/or sales spend, and wherein a manufacturing actuation relates to optimizing or reducing manufacture.

14. The non-transitory storage medium of claim 8, further comprising performing machine learning to increase a time between detection of an anticipated event and occurrence of the event.

15. A method, comprising:
generating tags for data received from sensors in a manufacturing environment configured to manufacture a product;
executing rules by a rules engine on the tags to identify variations in values of the data compared to expected values of the data;
performing a cost analysis to compare a cost of manufacturing the product with sales and/or marketing investment; and
triggering a first notification to initiate a manufacturing actuation based on a result of the cost analysis, wherein the first notification is triggered before or when an event occurs and manufacturing actuation includes adjusting production; and
performing the manufacturing actuation based on the result of the cost analysis.

16. The method of claim 15, further comprising receiving event information related to an anticipated event or an occurring event.

17. The method of claim 16, further comprising:
analyzing the event information to determine one or more of a geographic impact of the event, a nature of the event, a radius of the event, a time frame of the event and performing a threat assessment, and
performing an impact analysis that analyzes an impact of the event on consumption and an impact of the event on production, wherein the impact on consumption includes an analysis on a total product impact, available distribution to a new area, time to distribute the product, and a cost to move the product, wherein the impact on production includes an analysis on a cost of production, a time to production, and a cost to create consumption pipeline.

18. The method of claim 15, further comprising triggering a second notification to initiate the manufacturing actuation based on the result of the cost analysis, wherein the cost analysis accounts for a cost associated with the event.

19. The method of claim 15, further comprising:
performing machine learning to increase a time between detection of an anticipated event and occurrence of the event,
wherein a business actuation relates to increasing or decreasing marketing spend and/or sales spend, and wherein the manufacturing actuation relates to optimizing or reducing manufacture.

20. A non-transitory storage medium having stored therein instructions that are executable by one or more hardware processors to perform operations comprising the method of claim 15.
